(19) United States
(12) Patent Application Publication
(10) Pub. No.: US 2021/0091388 A1
(43) Pub. Date: Mar. 25, 2021

(54) METHOD AND EQUIPMENT FOR RECYCLING USED CELLS AND RECHARGEABLE BATTERIES

(71) Applicant: FIDAY GESTION, CHASSEY-LES-SCEY (FR)

(72) Inventor: Jean-Pierre GARNIER, Allondaz (FR)

(21) Appl. No.: 16/976,774

(22) PCT Filed: Mar. 1, 2019
(86) PCT No.: PCT/EP2019/055223

§ 371 Date: Aug. 31, 2020

(30) Foreign Application Priority Data
Mar. 1, 2018 (EP) 18159577.8

(51) Int. Cl. H01M 6/52; H01M 10/54; C22B 1/248; H01M 10/04; C21B 5/02; C21C 5/52

(52) U.S. Cl. CPC H01M 6/52; H01M 10/54; C22B 1/248; C21C 2005/5282; C21B 5/02; C21C 5/527; C21B 2200/00; H01M 10/0427

(57) ABSTRACT

A method for recycling used cells such as saline cells, alkaline cells, button cells and used rechargeable batteries, includes the step of introducing the cells and/or rechargeable batteries as feedstock into a metal melting furnace, at the charging door thereof. The cells and/or rechargeable batteries are subjected to a compression operation in order to remove the electrolytes contained in the cells and/or rechargeable batteries, prior to introducing the cells and/or rechargeable batteries into the metal melting furnace.

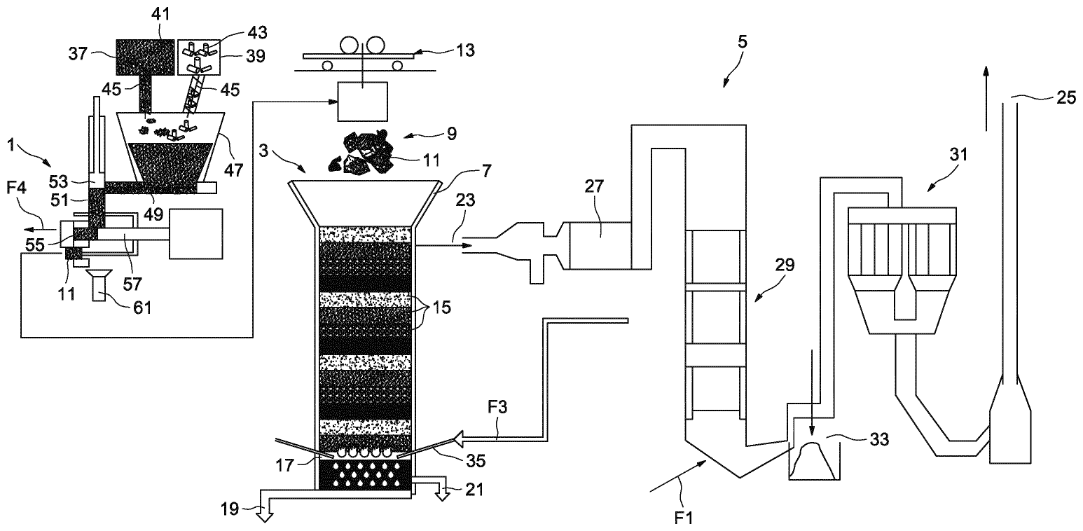

The method can be used for recycling used cells and rechargeable batteries.

### TECHNICAL FIELD

The disclosure relates to a method and equipment for recycling used cells such as saline cells, alkaline cells, button cells or used rechargeable batteries, by introducing the cells and/or rechargeable batteries as feedstock into a metal melting furnace such as a stack melting furnace or an arc furnace, at the charging door thereof.

### BACKGROUND

Methods and equipment of this type are already known, but have the drawback that the water of the electrolyte of the cells/rechargeable batteries, in a content level from 9 to 18%, must be evaporated, which is relatively costly in terms of energy, and more bothersome still, that the potassium or the alkalines as well as the chlorides present in the electrolyte can generate accelerated corrosion at the refractory materials of the furnace and exchangers intended to cool the fumes.

The disclosure aims to address this drawback.

### SUMMARY

To achieve this aim, the method according to the disclosure is characterized in that the cells and/or rechargeable batteries are subjected to a compression operation in order to remove the electrolytes contained in the cells and/or rechargeable batteries, prior to introducing the cells and/or rechargeable batteries into the metal melting furnace.

### BRIEF DESCRIPTION OF THE DRAWINGS

The disclosure will be better understood, and other aims, features, details and advantages thereof will appear more clearly, during the following explanatory description done in reference to the appended drawing, provided solely as an example illustrating one embodiment of the disclosure and in which the sole FIGURE is a schematic view of equipment for recycling cells and rechargeable batteries according to the disclosure.

### DETAILED DESCRIPTION OF THE DRAWINGS

The sole FIGURE schematically shows, as a nonexclusive example, equipment for implementing the method for recycling used cells, such as used saline cells, alkaline cells, button cells and rechargeable batteries from which one wishes to recycle the chemical elements in the cast iron or steel of a metal melting furnace like the stack melting furnace shown in the sole FIGURE. As will be explained in detail hereinafter, according to the method proposed by the disclosure, before introducing the cells and/or rechargeable batteries into the furnace, the electrolytes that the cells/rechargeable batteries contain are eliminated from the latter by compression, in particular to prevent the potassium hydroxide and chlorides in ion form contained in the cells/rechargeable batteries from being able to generate corrosion effects at the refractory materials of the furnace and exchangers intended to cool the fumes.

In the illustrated example of the disclosure, the electrolyte elimination operation is done in a pressurized briquetting operation of the cells/rechargeable batteries, in order to obtain a sub-product in the form of composite briquettes free of electrolytes and suitable for recycling in the melting furnace. In order to obtain briquettes strong enough to withstand the mechanical impacts that will occur during their loading in the furnace, the briquettes are made from a homogeneous mixture of turnings or chips of cast iron or steel with cells and/or rechargeable batteries. Additional elements such as a Black Mass powder of cells or rechargeable batteries, and optionally carbon and alloy elements interesting for the final quality of the produced cast iron or steel can be added to this mixture. Other additional elements can be added to the mixture before the briquette is pressed in order to seek neutrality among the basic and acid elements so as to minimize the risks of corrosion in the furnace and these annexes. The mixture of these different components of the briquettes must be as homogeneous as possible before the briquetting. In order to drive out the liquid electrolytes of the cells and/or rechargeable batteries introduced into the mixture, a minimum pressure of 2500 kg/cm² must be applied. The electrolytes can be collected for subsequent recycling.

The percentage of cells and/or rechargeable batteries or added powdered products must not exceed, in total and by weight, 40% of the weight of a briquette, to ensure the impact resistance of the briquettes.

In the schematic illustration of the equipment according to the disclosure, in the sole FIGURE, the briquetting device is indicated by reference 1, the melting furnace formed in the illustrated example by a stack melting furnace by reference 3, and reference 5 designates a system for scrubbing gases or fumes discharged from the furnace 3.

The stack melting furnace 3 has the conventional general structure, comprising a charging door 7 at the top for introducing feedstock into the furnace indicated at 9, in particular coke, steels, cast iron from recycling, briquettes of ferro-silicon or silicon carbide, various alloys as additives and a fluxing agent such as limestone in order to continuously capture and eliminate the non-fusible oxides, and of course, the briquettes designated by reference 11, which therefore include, in a homogeneous mixture with cast iron and steel chips and, if applicable, other additional elements, the cells and/or rechargeable batteries free of their electrolyte. These feedstocks are brought to the charging door by transport means indicated by reference 13. Reference 15 indicates the layers of feedstock in the stack melting furnace. The melting zone with the metal bath in the bottom of the liquid in the bottom of the stack melting furnace is designated by reference 17. References 19 and 21 respectively schematically show the outlets for the cast iron and the liquid slag.

The system 5 for scrubbing gases or fumes discharged from the furnace 3 essentially comprises, placed in series between the outlet 23 of the stack melting furnace and the discharge location into the atmosphere of the scrubbed gases 25, a combustion chamber 27 for burning the carbon monoxide, heat exchangers 29 in which the gases enter at a temperature of the order of 800° C. and leave at a temperature of the order of 250° C. and a bag filter 31. Reference 33 indicates the recovery location of the dust from the filter and which includes a large quantity of zinc. Downstream of the heat exchangers 29, arrow F1 symbolizes the injection of activated carbon-based product into the gases to relieve dioxins, furans and heavy metals. The stack melting furnace is equipped with devices for injecting air and oxygen above the melting zone 17, which contains the molten metal bath. The injecting device for example comprises five injection hoses 35 supplied by a supply ring, not shown. The air injected through the hoses is heated to a temperature of the order of 550-600° C. via the passage through one of the heat exchangers 29, as symbolized by arrow F3. The added heat makes it possible to save coke to be added. The exchangers make it possible to decrease the temperature of the gases before entering the bag filter 31, which does not withstand high temperatures for example exceeding 200° C.

The briquetting device 1 according to the disclosure essentially comprises two hoppers 37 and 39 for receiving cast iron or steel chips 41 and the cells and/or rechargeable batteries 43. A third hopper can be added for the additions of Black Mass or other additional product. The cells and the chips are conveyed by worms 45 controlled by motors with electric variable speed drives (not shown). These worms 45 convey the components from the hoppers to the supply hopper 47 of the briquetting machine. Depending on the speed supplied to the worms 45, it is possible to meter the components to be introduced into the briquetting machine hopper 47. The simultaneous introduction of the components makes it possible to obtain homogeneous mixtures in the hopper 47. The mixture is next driven by a worm 49 toward a precompression chamber 51. A piston 53 next pushes the mixture toward the compression chamber 55, in which a piston 57 then compresses the mixture under high pressure. After opening of the chamber, indicated schematically by arrow F4, the piston 57 expels the briquette 11, which will then be transported by the transport device 13 to the charging door of the stack melting furnace. A collector 61 makes it possible to collect the electrolytes obtained during the production of the briquettes.

The disclosure that has been described above, as a non-limiting example, has considerable economic and environmental advantages. The introduction of the cells and/or rechargeable batteries into the furnace in the form of composite briquettes makes it possible also to include waste therein, which is often powdered and inexpensive, whereof one wishes to recycle certain elements in the produced cast iron or steel. The elimination of the electrolytes makes it possible to limit the quantities of water that would otherwise have to be evaporated and to limit the ionic elements present in the electrolytes of the cells and rechargeable batteries, which makes it possible to reduce the costs related to the refractory corrosion of the furnace and the heat exchangers of the equipment.

On the environmental level, the disclosure makes it possible to recycle alkaline cells and saline cells as well as rechargeable batteries with an excellent efficiency, as well as manganese and the metals of the Black Mass of the cells and rechargeable batteries. By incorporating it into the composite briquettes, large quantities of waste, often powdered, containing elements such as carbon, manganese, zinc, silicon and metal elements such as vanadium, molybdenum, copper, nickel, cobalt and rare earths can be recycled.

Of course, the disclosure is not limited to the use of stack melting furnaces with hot or cold venting, but also makes it possible to use blast furnaces for producing cast iron ingots, electric arc furnaces or the like, intended to produce steel and cast iron with manganese or with nickel or cobalt, as long as the systems for treating the fumes make it possible to comply with the regulations regarding discharges into the atmosphere.

The quantity of filled composite briquettes will be based on the desired elements for the recycling thereof, namely the content in manganese, nickel, cobalt or the like to be obtained in the cast iron from the furnace or the steel or the ferro-alloy. The content in manganese, nickel or cobalt, or more generally in other metals, is not critical in the product to be produced; the filled quantity could be based on the zinc content sought in the filtration dusts of the gases from the melting equipment.

Another major advantage of the disclosure lies in the possibility of providing, at the outlet of the briquetting device, real-time inspection by X-ray fluorescence spectrometry on each briquette or for each batch in order to detect, at the source, any risk of pollution before briquettes are loaded in the furnace. Thus, for example rechargeable cell phone batteries using cadmium and nickel, which could be confused with alkaline and saline cells during sorting, can be detected and prevented from being introduced into the furnace.

1. A method for recycling used cells such as saline cells, alkaline cells, button cells and used rechargeable batteries, the method includes the steps of introducing the cells and/or rechargeable batteries as feedstock into a metal melting furnace, at the charging door thereof, wherein the cells and/or rechargeable batteries are subjected to a compression operation to remove the electrolytes contained in the cells and/or rechargeable batteries, prior to introducing the cells and/or rechargeable batteries into the metal melting furnace.

2. The method according to claim 1, wherein the cells and/or rechargeable batteries are mixed with shavings of cast iron or steel to obtain a homogenous mixture, the mixture undergoes the compression operation to form briquettes whereof the electrolyte has been removed, and the briquettes are introduced into the metal melting furnace.

3. The method according to claim 2, further including the step of adding additional elements to the mixture of cells and/or rechargeable batteries and chips of cast iron and/or steel, wherein additional elements such as a powder of Black Mass of cells or rechargeable batteries, carbon and alloy elements in order to obtain a cast iron or steel with a desired composition, before the briquetting operation.

4. The method according to claim 2, wherein the percentage of cells and/or rechargeable batteries and added elements does not exceed, in total and by weight, 40% of the total weight of a briquette.

5. The method according to claim 1, wherein the pressure to which the cells and/or rechargeable batteries are subjected to remove their electrolyte is greater than 2500 kg/cm².

6. The method according to claim 2, wherein the briquettes are subject to an inspection by X-ray fluorescence spectrometry before they are introduced into the metal melting furnace.

7. An equipment for implementing the method according to claim 1, wherein the method comprises a metal melting furnace and a briquetting device for forming the briquettes to be introduced as feedstock into the melting furnace, and in that the briquetting device comprises a hopper for receiving cells and/or rechargeable batteries, whole and as additives such as chips of cast iron or steel, this hopper being the supply hopper for a briquetting machine including a compression chamber for the mixture of cells/rechargeable batteries and additives and a collector for receiving electrolytes obtained during the production of the briquettes.

8. The equipment according to claim 7, wherein the metal melting furnace is a furnace such as a stack melting furnace, a blast furnace for producing cast iron ingots, or an electric arc furnace.

9. The equipment according to claim 7, wherein the briquetting device comprises means for forming a mixture of cells and/or rechargeable batteries, chips of cast iron and steel, if applicable, additional elements, and metering these components, before producing briquettes, and means for recovering the removed electrolyte.
